(19) United States
(12) Patent Application Publication
(10) Pub. No.: US 2015/0374469 A1
(43) Pub. Date: Dec. 31, 2015

(54) ORAL CAVITY MEASURING DEVICE, OCCLUSION EVALUATION SYSTEM AND NON-TRANSITORY COMPUTER READABLE MEDIUM

(71) Applicant: NIHON KOHDEN CORPORATION, Tokyo (JP)

(72) Inventors: Norihito Konno, Tokyo (JP); Hironori Kuroyone, Tokyo (JP)

(21) Appl. No.: 14/746,176

(22) Filed: Jun. 22, 2015

(30) Foreign Application Priority Data
Jun. 30, 2014 (JP) 2014-135030

(51) Int. Cl. A61C 19/05

(52) U.S. Cl. CPC A61C 19/05

(57) ABSTRACT

An oral cavity measuring device driven by a battery includes a sensing unit that includes one or more sensors which detect an occlusion state of teeth of a subject, a transmission timing setting unit that sets a data transmission timing based on the occlusion state detected by the sensing unit, and a transmission unit that transmits the occlusion state detected by the sensing unit based on the data transmission timing set by the transmission timing setting unit.

### CROSS REFERENCE TO RELATED APPLICATION

This application is based on Japanese Patent Applications No. 2014-135030 filed on Jun. 30, 2014, the contents of which are incorporated herein by reference.

### BACKGROUND

The present invention relates to an oral cavity measuring device, an occlusion evaluation system and a non-transitory computer readable medium.

In dentistry, rehabilitation field and the like, measuring an occlusion state of a subject is widely performed. When wishing to identify an occlusion state of the subject, techniques of causing the subject to bite a silver foil or using an occlusion force measuring device were performed.

However, the technique of using the silver foil or the technique of using the occlusion force measuring device are a troublesome to the subject and also take time. Therefore, oral cavity measuring devices having a wireless function were proposed.

What is disclosed in JP-A-2013-192865 is a mouthpiece which includes a pressure sensor on a surface thereof and transmits a pressure value acquired by the pressure sensor or the number of chewings through a wireless communication module. What is disclosed in JP-A-2004-167120 is a mouthpiece which acquires data such as body temperature and then wirelessly transmits the data to a medical center or the like.

The oral cavity measuring devices, including mouthpieces, are small device. Therefore, it is difficult to mount a large capacity battery into the oral cavity measuring devices. In general, a wireless communication is a processing involving a great consumption of the battery. However, in both of JP-A-2013-192865 and JP-A-2004-167120, there is no suggestion or notification on consumption of the battery. Therefore, in the related art, there is a problem in that consumption of the battery is increased due to wireless transmission of an occlusion state and thus it is difficult to stably monitor the occlusion state for a long time.

The present invention has been made keeping in mind the above matter, and a main object thereof is to provide an oral cavity measuring device, an occlusion evaluation system and a non-transitory computer readable medium storing a program, in which an occlusion state in an oral cavity can be transmitted while reducing consumption of a battery.

SUMMARY

According to an aspect of the invention, an oral cavity measuring device driven by a battery, includes a sensing unit that includes one or more sensors which detect an occlusion state of teeth of a subject, a transmission timing setting unit that sets a data transmission timing based on the occlusion state detected by the sensing unit, and a transmission unit that transmits the occlusion state detected by the sensing unit based on the data transmission timing set by the transmission timing setting unit.

According to another aspect of the invention, a non-transitory computer readable medium stores a program to execute processes in an oral cavity measuring device driven by a battery. The process includes setting a data transmission timing based on an occlusion state of teeth of a subject detected by a sensing unit, and transmitting the occlusion state detected by the sensing unit based on the data transmission timing.

According to another aspect of the invention, an occlusion evaluation system includes an oral cavity measuring device driven by a battery and an occlusion evaluation device. The oral cavity measuring device includes a sensing unit that includes one or more sensors which detect an occlusion state of a subject, a transmission timing setting unit that sets a data transmission timing based on the occlusion state detected by the sensing unit, and a transmission unit that transmits the occlusion state detected by the sensing unit based on the data transmission timing set by the transmission timing setting unit. The occlusion evaluation device performs evaluation processing on the occlusion state received from the oral cavity measuring device.

### BRIEF DESCRIPTION OF DRAWINGS

FIG. 1 is a view showing an exterior configuration of a mouthpiece 10 according to an embodiment 1.

FIG. 2 is a block diagram showing a configuration of an occlusion evaluation system according to the embodiment 1.

FIGS. 3A and 3B are views showing an occlusion state detected by sensors 200-1˜200-16 according to the embodiment 1.

FIG. 4 is a transmission rule table stored in a memory unit 32 according to the embodiment 1.

FIGS. 5A and 5B are views showing screens of an evaluation result displayed by the occlusion evaluation device 50 according to the embodiment 1.

FIG. 6 is a view showing an example of relationships between occlusion patterns and operation modes according to the embodiment 1.

FIG. 7 is a view showing a relationship between remains of a battery 40 and a data transmission timing according to the embodiment 1.

### DETAILED DESCRIPTION OF EMBODIMENTS

### Embodiment 1

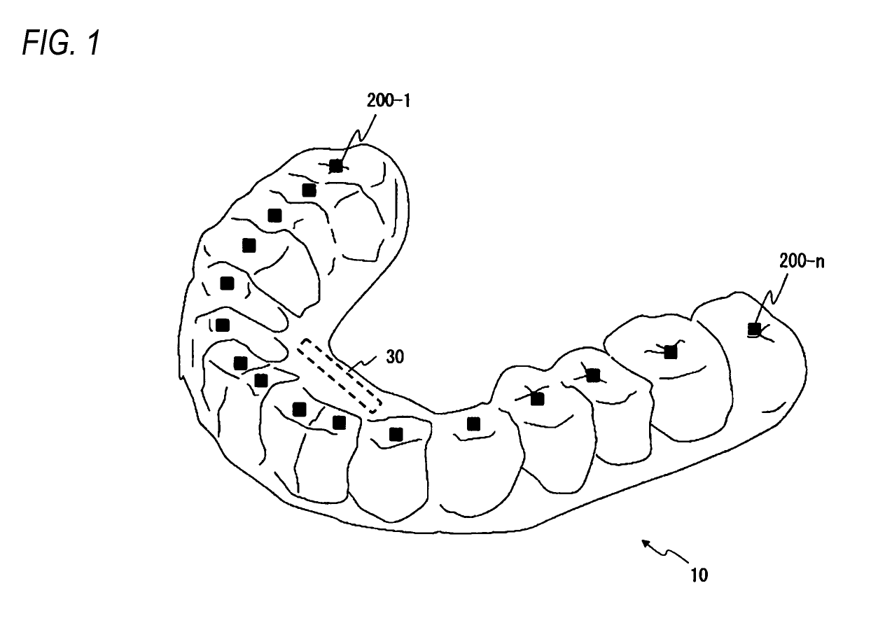

Now, an embodiment of the present invention will be described with reference to the accompanying drawings. FIG. 1 is a schematic view showing an exterior configuration of a mouthpiece 10 according to the present embodiment. In FIG. 1, tooth shapes or the like are simply shown. Meanwhile, the mouthpiece 10 shows one to be mounted on the lower teeth of a subject, but may be one configured to have the same configuration and to be mounted on the upper teeth. Also, the mouthpiece 10 is one example of an oral cavity measuring device mounted in an oral cavity. As the oral cavity measuring device, other devices, such as so-called false teeth, may be conceived.

As shown, the mouthpiece 10 is provided with a plurality of sensors (200-1˜200-n) on an occlusion surface thereof. Also, the mouthpiece 10 has a microcomputer 30 inside thereof. The mouthpiece 10 is used in wide applications, such as detection or analysis of dysphagia, identifying of rehabilitation effects or identifying of effects of intraoral treatments or the like.

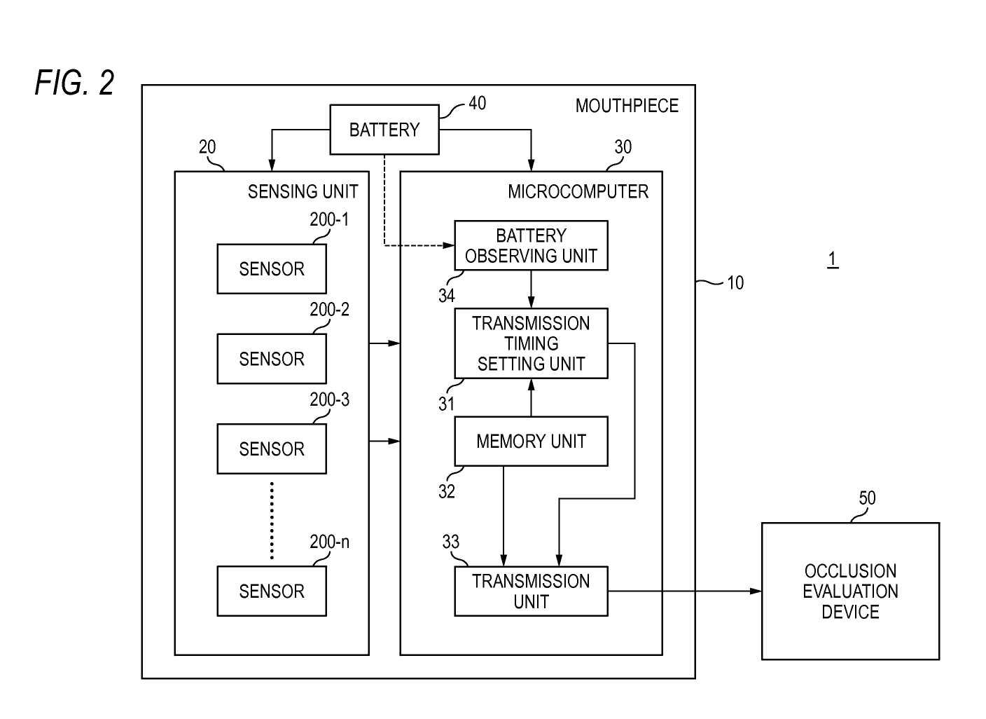

FIG. 2 is a block diagram showing a configuration of an occlusion evaluation system according to the present embodiment. The occlusion evaluation system 1 has the mouthpiece 10 and an occlusion evaluation device 50. The occlusion evaluation device 50 is, for example, a server device having a large capacity memory storage and is configured to receive, store and evaluate data transmitted from the mouthpiece 10.

The mouthpiece 10 has a sensing unit 20 including sensors 200-1˜200-n (n is a natural number of 2 or more) provided on the occlusion surface, the microcomputer 30 and a battery 40. The microcomputer 30 has a transmission timing setting unit 31, a memory unit 32, a transmission unit 33 and a battery observing unit 34. Meanwhile, the microcomputer may appropriately have general MPU (Micro-Processing Unit) and A/D (Analog/Digital)converters, not shown.

The battery 40 supplies electric power each processing unit of the mouthpiece 10 (including the sensing unit 20 and the microcomputer 30). For example, the battery 40 is a button cell. As the battery 40 supplies electric power, the mouthpiece 10 is driven.

Each of sensors 200-1˜200-n measures an occlusion pressure in the oral cavity in real time. Meanwhile, in the following description, information including an occlusion pressure at each location in the oral cavity is referred to as “occlusion state”. The occlusion state is one in which an occlusion pressure detected at each location in the oral cavity is associated with a time. The sensing unit 20 detects an occlusion state of a subject and supplies the occlusion state to the microcomputer 30. The sensing unit 20 may be a configuration having one or more sensor, but has an excellent effect when being a configuration having sensors provided to correspond to each tooth.

The battery observing unit 34 periodically observes remains of the battery 40 and notifies information on remains of the battery 40 (hereinafter, referred to as ‘battery remains information’) to the transmission timing setting unit 31.

The memory unit 32 stores various information in the microcomputer 30. For example, the memory unit 32 is a small hard disk drive. The memory unit 32 stores an occlusion state, which is measured by the sensing unit 20 and associated with the date and time of measurement (or any information enabling to grasp acquisition timing thereof).

The transmission timing setting unit 31 is a processing unit for setting a timing at which the transmission unit 33 transmits the occlusion state. The occlusion state from the sensing unit 20 and the battery remains information from the battery observing unit 34 are inputted to the transmission timing setting unit 31. Next, a method of setting a data transmission timing by the transmission timing setting unit 31 will be described together with specific examples thereof.

First, the simplest example will be described. The transmission timing setting unit 31 may set a data transmission timing so that the occlusion state is transmitted when occlusion equal to or higher than a predetermined force is occurred. Thus, data transmissions can be maintained to the required minimum number of times.

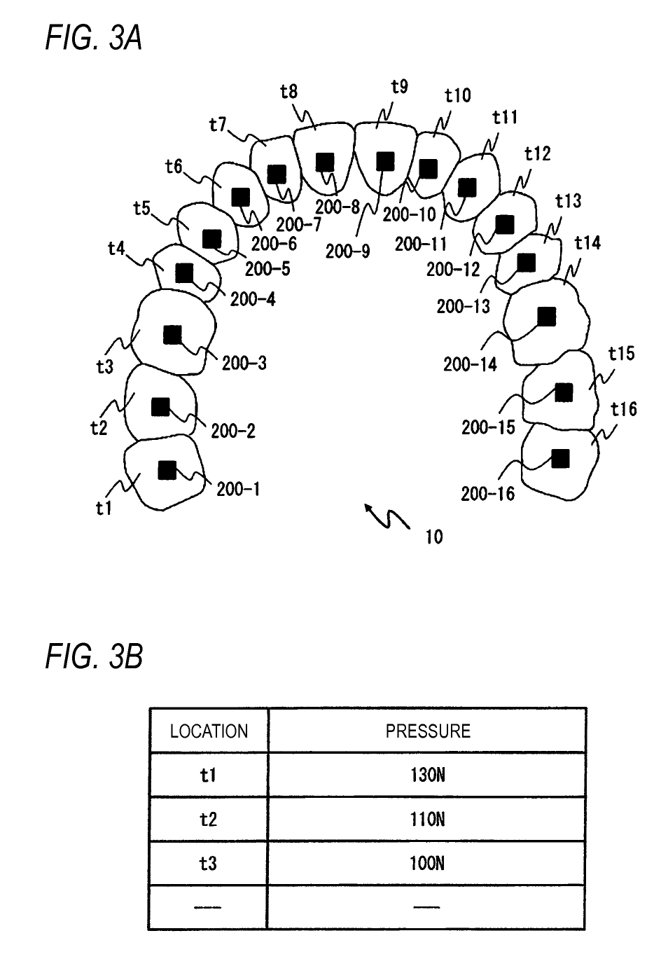

Also, the transmission timing setting unit 31 may sets a transmission timing by comparing the occlusion state with, for example, a transmission rule table. An occlusion state detected by the sensors 200-1˜200-16 will be first described with reference to FIGS. 3A and 3B. FIG. 3A and 3B show a relationship between an embedded state of the sensors 200-1˜200-16 of the mouthpiece 10 and an occlusion state detected by the sensors 200-1˜200-16.

Referring to FIG. 3A, the mouthpiece 10 is configured so that one of sensors 200-1˜200-16 is embedded in each of teeth t1˜t16. Each of sensors 200-1˜200-16 notifies a detected pressure to the microcomputer 30. FIG. 3B shows an example of a pressure (occlusion state) detected by each of sensors 200-1˜200-16. In the example of FIG. 3B, a pressure of 130 N is occurred at the tooth t1 and a pressure of 110 N is occurred at the tooth t2. Such a pressure occurred at each of teeth t1˜t16 is notified to the microcomputer 30 in real time.

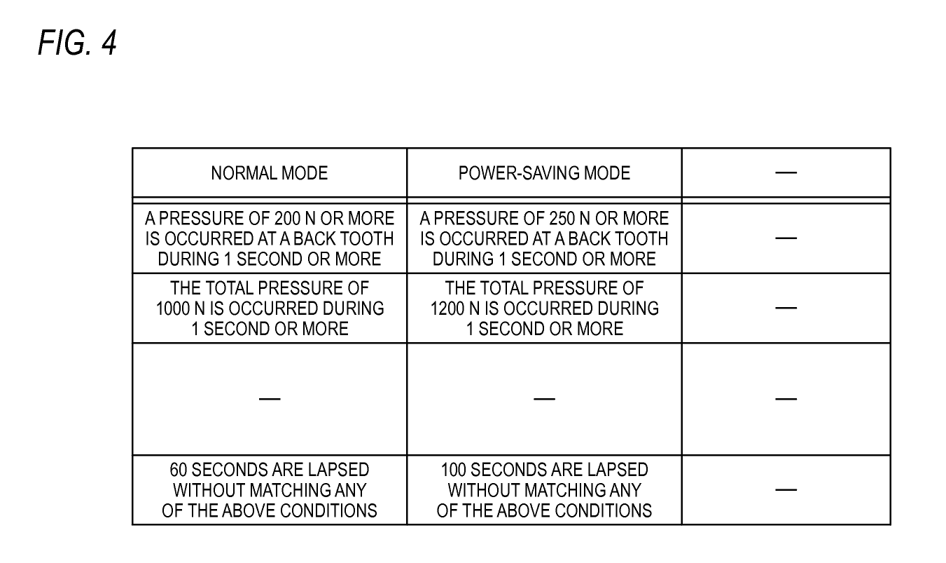

FIG. 4 is an example of a transmission rule table stored in the memory unit 32. The transmission rule table is provided with a plurality of operation modes (normal mode, electric power saving mode or the like). It is preferable that a subject can appropriately set an operation mode to the mouthpiece 10 depending on measurement purposes (rehabilitation effect measurement, sports effect measurement, measurement on sleep or the like). The subject sets an operation mode by an operation unit, not shown, or a wireless communication input from other device before using the mouthpiece 10. Meanwhile, FIG. 4 is merely one example, and thus the mouthpiece 10 may have a configuration in which an operation mode thereof cannot be set (configuration in which the mouthpiece is operated at a single operation mode).

For each operation mode, rules on a timing at which an occlusion state is transmitted are prescribed. For example, in the case of the normal mode, transmitting data when a pressure of 200 N or more is occurred at a back tooth (tooth t1 or tooth 16 in the example of FIG. 3A) during 1 second or more, transmitting data when the total pressure of all teeth t1˜t16 is 1000 N or more during 1 second or more, or the like are prescribed. On the other hand, in the case of the electric power saving mode, transmitting data when a pressure of 250 N or more is occurred at a back tooth (tooth t1 or tooth 16 in the example of FIG. 3A) during 1 second or more, transmitting data when the total pressure of all teeth t1˜t16 is 1200 N or more during 1 second or more, or the like are prescribed.

Meanwhile, ever for any operation modes, a rule of performing transmission if transmission has not been performed throughout a predetermined period of time (e.g., in the case of the normal mode, when transmission has not been performed throughout 60 seconds) has to be prescribed. Thus, data to be transmitted from the mouthpiece 10 can be prevented from having an excessive large volume, and also a situation where evaluation processing of the occlusion evaluation device 50 is delayed can be avoided.

The transmission timing setting unit 31 evaluates in real time whether or not an occlusion state (i.e., information on a pressure occurred at teeth) conforms to rules as shown in FIG. 4 and sets a timing, at which the state comes to conform to the rules, as a timing at which data has to be transmitted (data transmission timing). Then, the transmission timing setting unit 31 notifies an instruction for data transmission to the transmission unit 33.

Although in the example of FIG. 4, the transmission timing setting unit 31 sets a timing, at which the state meets even any one of rules (so-called OR condition), as a data transmission timing, a timing at which two or more of the rules are simultaneously met (so-called AND condition) may be set as the data transmission timing.

Also, the data transmission timing setting unit 31 may set a data transmission timing, which involves the time appointment that ‘data transmission is preformed after 3 seconds’ for the transmission unit 33.

The transmission unit 33 reads data of an occlusion state, which is not yet transmitted, from the memory unit 32 according to the data transmission timing set by the data transmission timing setting unit 31 and then wirelessly transmits the data to the occlusion evaluation device 50. Thus, the transmission unit 33 is a processing unit, on which a wireless communication protocol or the like is mounted.

The occlusion evaluation device 50 is a device for receiving and evaluating the occlusion state transmitted from the transmission unit 33 of the mouthpiece 10. The occlusion evaluation device 50 may be a general server device or PC (Personal Computer). The occlusion evaluation device 50 has CPU (Central Processing Unit), a hard disk drive, a cache memory and the like.

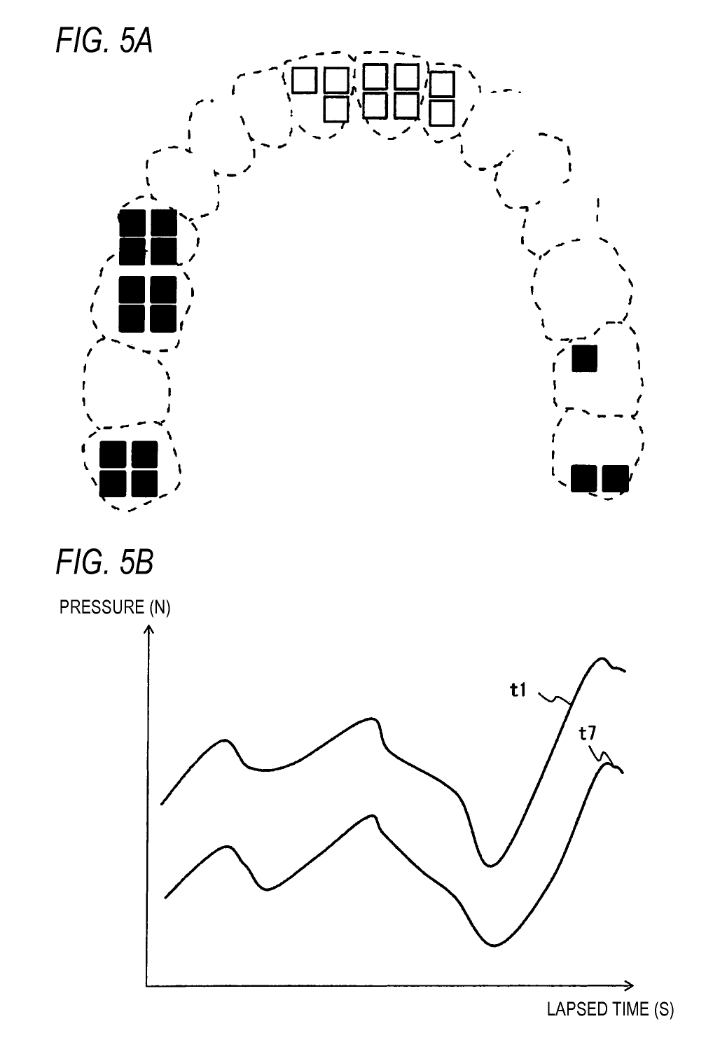

The occlusion evaluation device 50 evaluates the received occlusion state by various techniques and presents the evaluation result to a user (or stores the result in a hard disk). FIGS. 5A and 5B are views showing screens of the evaluation result displayed by the occlusion evaluation device 50.

FIG. 5A is a view graphically showing magnitudes of pressures in the oral cavity at a certain time point. In the screen, colors of dots are varied according to magnitudes of pressures, thereby notifying pressures in the oral cavity.

Also, FIG. 5B shows transition in pressure at each tooth (tooth t1 and tooth t7 in the example of FIG. 5B) depending on an elapsed time. The user can recognize whether or not a degree of pressure change is different depending on locations of teeth and the like by referring to the graph.

Subsequently, effects of the mouthpiece 10 (oral cavity measuring device) according to the present embodiment will be described. As described above, the mouthpiece 10 evaluates an oral state and sets a data transmission timing depending on the evaluation. Preferably, the mouthpiece 10 is controlled so that data transmission is performed when an occlusion state meets a predetermined condition (a condition considered that evaluating an oral state is desired). Thus, data transmissions are performed at the required minimum number of times so that consumption of the battery 40 can be reduced to the minimum. In other words, transmission processing can be performed when data transmissions have to be performed, and also data transmissions can be performed only at the optimal number of times, thereby reliably performing evaluation of the occlusion state while reducing consumption of the battery 40.

A specific power-saving effect for the battery 40 will be examined. It is said that the number of occlusions of modern people during eating is about 600 times. See a web page at http://www.izumi-shika-iin.jp/qa/qa004.html. In general, occlusions corresponding to 600 times are not occurred in cases other than eating, but herein it is assumed that occlusions of 600 times are occurred. It is assumed that the mouthpiece 10 performs a data transmission every time when an occlusion is occurred. Also, as a comparative example, it is assumed that an occlusion state is periodically transmitted at every ten seconds.

In this case, the comparative example occurs data transmissions 8640 times a day (3600 seconds×24 hours/10 seconds). Contrarily, the mouthpiece 10 according to the present embodiment performs data transmission only about 600 times a day. The mouthpiece 10 according to the embodiment can realize a reduced battery consumption corresponding to about 14 times (8640 times/600 times) lower than that of the comparative example.

Also, the transmission timing setting unit 31 can set a data transmission timing in such a manner that a detailed rule as shown in FIG. 4 compares an occlusion state with a predetermined table. Thus, the transmission timing setting unit 31 can realize detail and accurate setting of the data transmission timing.

Herein, rules for each operation mode are set in the table of FIG. 4. In this way, a data setting timing can be set in consideration of operation modes, so that the transmission unit 33 can perform data transmissions at a required minimum frequency depending on applications of the mouthpiece 10 (whether the mouthpiece 10 is used in a daily life or used to identify rehabilitation effects or the like).

In the foregoing, the invention achieved by the present inventors has been described in detail based on the embodiment, but it will be appreciated that the present invention is not limited to the above mentioned embodiment and various modifications thereof can be made without departing from the spirit thereof. In the following, various variants will be described.

(Variant 1)

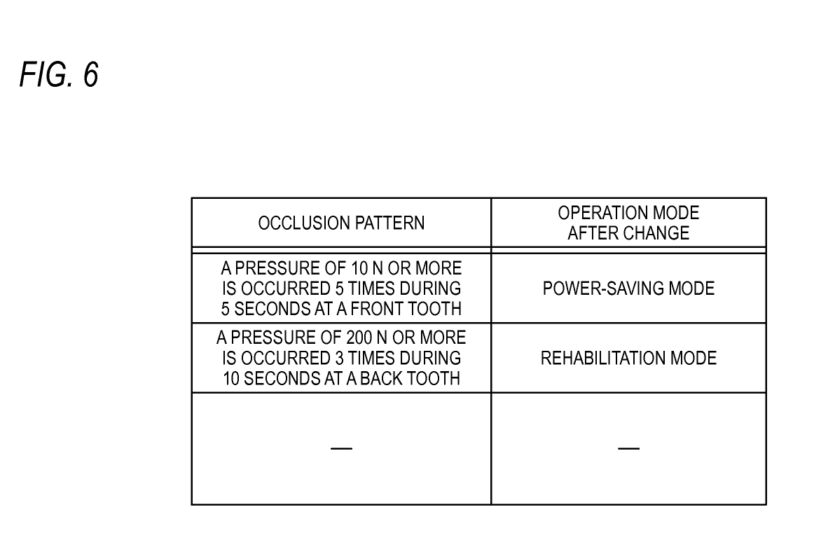

In the foregoing description, the mouthpiece 10 has been described as having a plurality of operation modes (FIG. 4), but may be configured so that the operation mode thereof is switched when a user performs a predetermined occlusion pattern. FIG. 6 is a view showing an example of relationships between occlusion patterns and operation modes.

For example, the transmission timing setting unit 31 switches the operation mode into the power-saving mode when a pressure of 10 N or more is detected 5 times during 5 seconds at a front tooth. A subject performs occlusion corresponding to an operation mode, to which the subject wishes to switch, while mounting the mouthpiece 10 in an oral cavity. Meanwhile, when switching the operation mode by detecting the occlusion pattern, the transmission timing setting unit 31 may notify change of the operation mode to the user by outputting a sound from a speaker, not shown, of the mouthpiece 10, vibration or the like.

Due to the configuration as described above, the subject can switch the operation mode of the mouthpiece 10 by a simple motion without removing the mouthpiece 10.

(Variant 2)

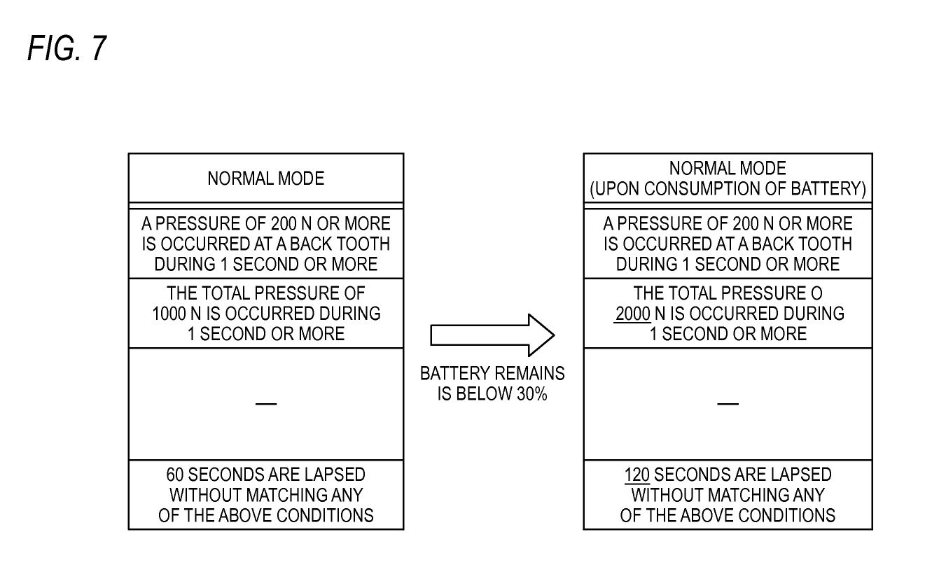

The mouthpiece 10 may set a data transmission timing in consideration of remains of the battery 40. A specific example will be described with reference to FIG. 7.

As described above, the battery observing unit 34 periodically observes remains of the battery 40 and then notifies a battery remains information to the transmission timing setting unit 31. With reference to the battery remains information, the battery timing setting unit 31 performs the operation as described above when remains of the battery 40 is above a predetermined value.

The transmission timing setting unit 31 performs control so that a threshold value, which is used in comparison for data transmissions, is increased when remains of the battery 40 is below the predetermined value. In an example of FIG. 7, when remains of the battery becomes below 30%, the transmission timing setting unit 31 changes the rule that ‘data is transmitted when the total pressure applied on all teeth is 1000 N or more during 1 second or more’ into a rule that ‘data is transmitted when the total pressure applied on all teeth is 2000 N or more during 1 second or more’.

Meanwhile, the transmission timing setting unit 31 may perform control so that the operation mode is switched when remains of the battery 40 is below the predetermined value. For example, the transmission timing setting unit 31 may switch the operation mode from the normal mode to the power-saving mode when remains of the battery 40 becomes below 20%.

As described above, because the data transmission timing is set depending on remains of the battery, the mouthpiece 10 can perform data transmissions with the set transmission timing for a long time even when remains of the battery 40 is small.

(Variant 3)

The mouthpiece 10 may be configured so that when remains of the battery 40 becomes small (i.e., becomes below the predetermined value), this is notified to the subject or the like. For example, when remains of the battery becomes 30%, the mouthpiece 10 may output a sound from a speaker embedded therein. When remains of the battery becomes 30%, the mouthpiece 10 may display a calling attention about the battery remains on a display screen of the occlusion evaluation device 50 through the transmission unit 33. In addition, when remains of the battery becomes 30%, the mouthpiece 10 may notify consumption of the battery remains by so-called vibration (by minutely moving the mouthpiece in the oral cavity of the subject).

As described above, because the mouthpiece 10 notifies consumption of the battery remains, the subject can take the action of charging or exchanging the battery 40 before the battery is discharged.

(Variant 4)

The transmission unit 33 may delete data of an occlusion state, of which transmission has been completed, from the mouthpiece 10 in accordance with a predetermined rule (immediately deleting, or deleting the oldest data) when the data volume becomes above a predetermined value. In the following, two specific examples will be described.

The transmission unit 33 may read out and transmit data of an occlusion state from the memory unit 32 and then delete the data from the memory unit 32 after completion of transmission. Accordingly, a situation where the capacity of the memory unit 32 runs short can be avoided.

Also, the transmission unit 33 may be configured so that a required minimum volume of data in order from the oldest data is deleted from the memory unit 32 after the data volume become above the predetermined value. Accordingly, the capacity shortage of the memory unit 32 can be avoided while maintaining a state where a required data can be referred from the mouthpiece 10.

Also, processing in the transmission setting unit 31 and the transmission unit 33 as described above may be embodied as computer programs, which are operated in the mouthpiece 10. Herein, the programs can be stored using various types of non-transitory computer readable media and be supplied to a computer. The non-transitory computer readable media include various types of tangible storage media. Examples of non-transitory computer readable media include magnetic recording media (e.g., a flexible disk, a magnetic tape, a hard disk drive), magneto-optical recording media (e.g., a magneto-optical disk), CD-ROM (Read Only Memory), CD-R, CD-R/W, semiconductor memories (e.g., mask ROM, PROM(Programmable ROM), EPROM(Erasable PROM), flash ROM, RAM(random access memory)). Also, the programs may be supplied to the computer by various types of transitory computer readable media. Examples of transitory computer readable media include electrical signals, optical signals and electromagnetic waves. The transitory computer readable media can supply the programs to the computer through a wire communication path, such as electric wires or optic fibers, or a wireless communication path.

According to the present invention, an occlusion state is evaluated and a data transmission timing is set depending on the evaluation. As a result, data transmissions can be performed at the required minimum number of times, so that consumption of the battery can be reduced to the minimum.

The present invention can provide an oral cavity measuring device, an occlusion evaluation system and a program, in which an occlusion state in an oral cavity can be transmitted while reducing consumption of a battery.

What is claimed is:

1. An oral cavity measuring device driven by a battery, comprising:
a sensing unit that includes one or more sensors which detect an occlusion state of teeth of a subject;
a transmission timing setting unit that sets a data transmission timing based on the occlusion state detected by the sensing unit; and
a transmission unit that transmits the occlusion state detected by the sensing unit based on the data transmission timing set by the transmission timing setting unit.

2. The oral cavity measuring device according to claim 1, wherein the transmission timing setting unit sets the data transmission timing by comparing the occlusion state with a table, in which predetermined transmission rules are prescribed.

3. The oral cavity measuring device according to claim 1, wherein the transmission timing setting unit sets the data transmission timing in consideration of remains of the battery equipped in the oral cavity measuring device, in addition to the occlusion state detected by the sensing unit.

4. The oral cavity measuring device according to claim 3, wherein the oral cavity measuring device notifies that the remains of the battery becomes below a predetermined value in a case where the remains of the battery becomes below the predetermined value.

5. The oral cavity measuring device according to claim 1, wherein the transmission timing setting unit controls the transmission unit to perform transmission processing in a case where the transmission is not performed during a predetermined period of time.

6. The oral cavity measuring device according to claim 1, wherein the transmission timing setting unit sets the data transmission timing in consideration of an operation mode associated with setting of the data transmission timing, in addition to the occlusion state detected by the sensing unit.

7. The oral cavity measuring device according to claim 6, wherein the transmission timing setting unit changes the operation mode associated with setting of the data transmission timing when a predetermined occlusion pattern is detected.

8. The oral cavity measuring device according to claim 1, wherein the transmission unit deletes data of the occlusion state, of which transmission has been completed, from the oral cavity measuring device in accordance with a predetermined rule.

9. A non-transitory computer readable medium storing a program to execute processes in an oral cavity measuring device driven by a battery, the processes comprising:
setting a data transmission timing based on an occlusion state of teeth of a subject detected by a sensing unit; and
transmitting the occlusion state detected by the sensing unit based on the data transmission timing.

10. An occlusion evaluation system comprising an oral cavity measuring device driven by a battery and an occlusion evaluation device,
wherein the oral cavity measuring device includes:
a sensing unit that includes one or more sensors which detect an occlusion state of a subject;
a transmission timing setting unit that sets a data transmission timing based on the occlusion state detected by the sensing unit; and
a transmission unit that transmits the occlusion state detected by the sensing unit based on the data transmission timing set by the transmission timing setting unit; and
wherein the occlusion evaluation device performs evaluation processing on the occlusion state received from the oral cavity measuring device.
